(19) United States
(12) Patent Application Publication
(10) Pub. No.: US 2024/0167829 A1
(43) Pub. Date: May 23, 2024

(54) METHOD FOR PLANNING TO CHARGE AN ELECTRIC VEHICLE AND A VEHICLE DRIVING CONTROL APPARATUS

(71) Applicants: HYUNDAI MOTOR COMPANY, Seoul (KR); KIA CORPORATION, Seoul (KR)

(72) Inventors: Min Soo Woo, Gunpo-si (KR); Dae Kwang Kim, Seongnam-si (KR)

(73) Assignees: HYUNDAI MOTOR COMPANY, Seoul (KR); KIA CORPORATION, Seoul (KR)

(21) Appl. No.: 18/242,410

(22) Filed: Sep. 5, 2023

(30) Foreign Application Priority Data
Nov. 9, 2022 (KR) 10-2022-0148694

(51) Int. Cl. G01C 21/34; G01C 21/36

(52) U.S. Cl. CPC G01C 21/3469; G01C 21/3492; G01C 21/3679; G01C 21/3691

(57) ABSTRACT

A method of planning to charge an electric vehicle includes: determining a driving path based on a destination; dividing a prediction range on the driving path into a plurality of sections; obtaining driving environment information of the driving path; and applying the driving environment information to a charging plan model for each of the plurality of sections using and establishing a charging plan on the driving path by collectively calculating to find a minimized solution of the charging plan model for the plurality of sections. The charging plan model includes an objective function of travel time and battery state of charge (SOC). The objective function is defined based on a first model according to a longitudinal motion equation of the vehicle, a second model for the travel time, and a third model for the battery SOC.

### CROSS-REFERENCE TO RELATED APPLICATION

The present application claims priority to Korean Patent Application No. 10-2022-0148694, filed on Nov. 9, 2022, the entire contents of which are incorporated herein by reference.

### BACKGROUND

### Field of the Present Disclosure

The present disclosure relates to a method for planning to charge an electric vehicle and an apparatus fir vehicle driving control using the same.

### Discussion of Related Art

In accordance with the carbon neutral policy, countries around the world are strengthening support for eco-friendly vehicles such as electric vehicles. Following this trend can expect that the number of internal combustion engine vehicles will diminish on the road in the next few years.

These eco-friendly vehicles are generally driven by a motor that is supplied with power from an eco-friendly energy. As an example, an electric vehicle (including a hybrid vehicle) is supplied with power from a battery mounted therein and the motor is driven to drive the vehicle.

When the path to a destination is far, charging an eco-friendly vehicle may be required more than once, and in this case, charging is generally performed for each charging.

However, a battery charging curve exists depending on the battery protection and battery hardware characteristics, and a charging speed varies depending on the battery state of charge (SOC). When the SOC of the battery is increased, a charging speed is significantly decreased, and thus a time required for charging is increased to reach a destination.

### SUMMARY

Various aspects of the present disclosure are directed to providing a battery charging planning method and a driving control apparatus thereof, which can provide a battery charging plan while minimizing the time of arrival to a destination.

In an embodiment of the present disclosure, a method or an apparatus is provided for driving control capable of determining where to and how much to charge a vehicle among a plurality of charging stations in order to attain arrival at a destination in the shortest time.

A method of planning to charge an electric vehicle, according to an embodiment of the present disclosure, includes determining a driving path based on a destination and dividing a prediction range on the driving path into a plurality of sections. The method also includes obtaining driving environment information of the driving path and applying the driving environment information to a charging plan model for each of the plurality of sections using and establishing a charging plan on the driving path by collectively calculating to find a minimized solution of the charging plan model for the plurality of sections. The charging plan model includes an objective function of travel time and battery state of charge (SOC). The objective function is defined based on a first model according to a longitudinal motion equation of the vehicle, a second model for the travel time, and a third model for the batter SOC.

In at least one embodiment of the present disclosure, the first model is defined as a relationship between a vehicle speed and a driving force and a braking force. The second model is defined as a relationship between a vehicle speed and a travel distance. The third model is defined based on power consumed by the travelling of the vehicle, power charged by regenerative braking, and power charged by a charger.

In at least one embodiment of the present disclosure, the objective function includes a sum of weighted terms of the travel time and the battery SoC.

In at least one embodiment of the present disclosure, the term of the travel time includes a square of the travel time and the term of the battery SoC includes a square of the battery SoC.

In at least one embodiment of the present disclosure, the driving environment information includes at least one of charging station information, a road gradient, a road curvature, a speed limit, or a speed limit camera location, or any combination thereof.

In at least one embodiment of the present disclosure, the charging planning model includes at least one of a vehicle speed constraint, a motor driving force constraint depending on a vehicle speed, a motor braking force constraint, a constraint of a number of times of charging, an SoC operation constraint, a destination SoC constraint, or a vehicle speed constraint depending on road curvature, or any combination thereof.

In at least one embodiment of the present disclosure, collectively calculating to find the minimized solution includes performing a first calculation to find the minimized solution, then determining whether the number of times of charging and a target vehicle speed are satisfied, and includes performing a second calculation to find the minimized solution according to a result of determining the number of times of charging and the target vehicle speed.

In at least one embodiment of the present disclosure, in a case where the number of times of charging is satisfied but the target vehicle speed is not satisfied, performing the second calculation includes terminating the collectively calculating without the second calculation if a travel time resulted from the first calculation is satisfied and otherwise performing the second calculation with a number of times of charging of the constraint of the number of times of charging increased.

In at least one embodiment of the present disclosure, in a case where the target vehicle speed is satisfied but the number of times of charging is not satisfied, the performing of the second calculation includes terminating the collectively calculating without the second calculation if the number of times of charging resulted from the first calculation is equal to or smaller than a predetermined value and otherwise performing the second calculation with a number of times charging of the constraint of the number of times of charging decreased.

In at least one embodiment of the disclosure, the destination SoC is determined by a selection of a driver.

In at least one embodiment of the present disclosure, the destination SoC is determined depending on a location of a charging station closest from the destination.

A non-transitory computer-readable storage medium, according to an embodiment of the present disclosure, stores computer program code for performing a method described above by being executed by a computer processor.

A driving control apparatus, according to an embodiment of the present disclosure, comprises a navigation device configured to determine a driving path based on a destination, and a charging planner including at least one computer processor configured to perform a method described above.

In accordance with at least one embodiment of the present disclosure, it is possible to achieve the shortest travel time including the battery charge time in a vehicle, such as for example, an electric vehicle or a hybrid vehicle, including the travel by a battery and a motor.

### BRIEF DESCRIPTION OF THE DRAWINGS

FIG. 1 is a conceptual drawing of a driving control apparatus according to an embodiment of the present disclosure.

FIG. 2 shows a flowchart of a charging planning method according to an embodiment of the present disclosure.

FIG. 3 illustrates an instance in which a predictive horizon is divided into N unit sections.

FIG. 4 is a vehicle driving schematic diagram for describing an embodiment for state variable modeling of a longitudinal motion equation.

FIG. 5 is a drawing for explaining an example of a condition of “constraint of driving force of a motor depending on the vehicle speed”.

FIGS. 6A and 6B illustrate a result of an embodiment of the present disclosure when manually and automatically setting a “destination SoC condition”.

FIG. 7 is a view fir explaining an example of a “vehicle speed constraint according to road curvature” condition.

FIG. 8 conceptually illustrates that the minimum value (optimal solution) of the objective function P is determined while satisfying the constraint according to an embodiment of the present disclosure.

FIG. 9 conceptually illustrates that a minimum value of an objective function is determined when the objective function is a linear function.

FIG. 10 illustrates an example of a simulation result of a charging planning model according to an embodiment of the present disclosure.

FIG. 11 is a partial flowchart of a charging planning method according to an embodiment of the present disclosure.

FIGS. 12 and 13 illustrate examples of a simulation result of a charging planning model according to an embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, the same reference numerals refer to the same or equivalent parts of the present disclosure throughout the several figures of the drawings.

### DETAILED DESCRIPTION

The present disclosure may be modified in various ways and have various embodiments. Specific embodiments are illustrated in the drawings and described with respect thereto. However, this is not intended to limit the present disclosure to specific embodiment. It should be understood that the present disclosure includes all modifications, equivalents, and replacements included on the idea and technical scope of the present disclosure.

The suffixes “module” and “unit” used in the present specification are used only for name division among components and should not be construed as being physically divided or separated, or assuming that they may be so divided or separated. Also, when a component, device, element, or the like of the present disclosure is described as having a purpose or performing an operation, function, or the like, the component, device, or element should be considered herein as being “configured to” meet that purpose or perform that operation or function.

Terms including ordinals such as “first,” “second,” and the like, may be used to describe various elements, but the elements are not limited by the terms. The terms are used only for the purpose of distinguishing one element from another element.

The term “and/or” is used to include all instances of any terms agreed upon among a plurality of items to be covered. For example, “A and/or B” includes all three cases such as “A”, “B”, as well as “A and B”.

When it is stated that an element is “connected” or “connected” to another element, it should be understood that the component may be directly connected or connected to the other element, but another element may exist in between.

The terminology used herein is for the purpose of describing particular embodiments only and is not intended to be limiting of the disclosure. Singular expressions include plural expressions unless the context clearly indicates otherwise. In the present application, it should be understood that the terms “include” or “have” and variations thereof indicate that a feature, a number, a step, an operation, a component, a part, or a combination thereof described in the specification is present. Such terms do not exclude the possibility of existence or addition of one or more other features, numbers, steps, operations, components, parts, or combinations thereof in advance.

Unless otherwise defined, all terms used herein, including technical or scientific terms, have the same meaning as that generally understood by those of ordinary skill in the art. It should be further understood that terms, such as those defined in commonly used dictionaries, should be interpreted as having a meaning that is consistent with their meaning in the context of the related art and should not be interpreted in an idealized or overly formal sense unless expressed herein.

Furthermore, the term “unit” or “control unit”, for example included in the names of a hybrid control unit (HCU), a motor control unit (MCU), and the like. are merely widely used terms for naming a controller configured for controlling a specific vehicle function. Such terms do not mean a generic functional unit. For example, each unit may include a communication device communicating with another unit or sensor, a non-transitory memory storing an OS or logic command, input/output information, and the like, and one or more processors (e.g., computer, microprocessor, CPU, ASIC, circuitry, logic circuits, and the like) performing its programmed functionality through judgment, calculation, determination, and the like.

The computer-readable medium includes all types of recording devices in which data readable by a computer system is stored. Examples of the computer-readable medium include a hard disk drive (HDD), a solid-state drive (SSD), a silicon disk drive (SDD), a read-only memory (ROM), a random-access memory (RAM), a CD-ROM, a magnetic tape, a floppy disk, an optical data storage device, and the like. Therefore, the detailed description should not be construed as restrictive and should be considered as illustrative in all respects. The scope of the present disclosure should be determined by a reasonable interpretation of the appended claims and all modifications within the equivalent scope of the present disclosure are included in the scope of the present disclosure.

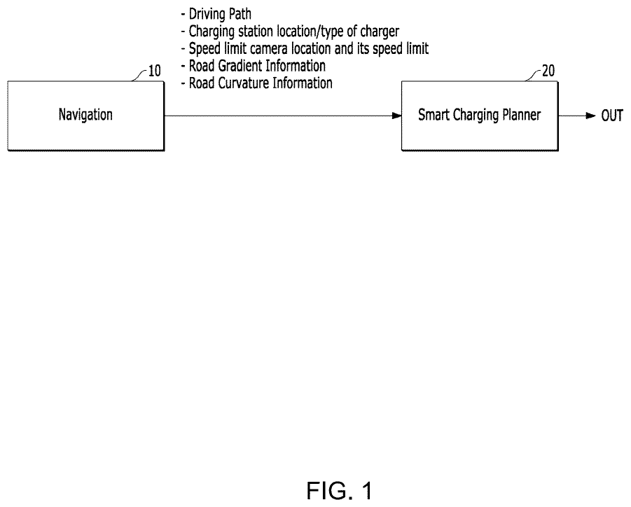

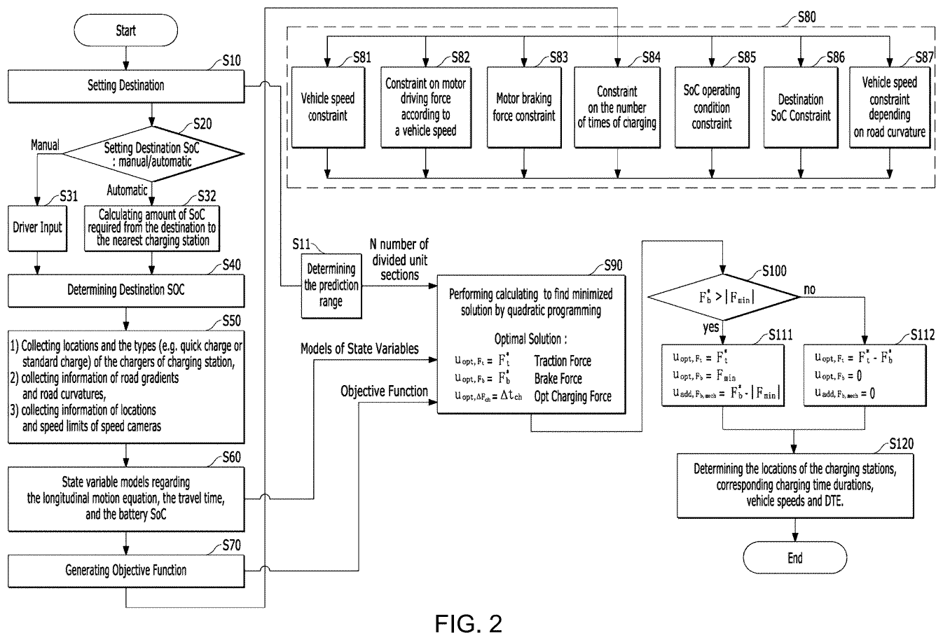

FIG. 1 shows an operation control apparatus according to an embodiment of the present disclosure. FIG. 2 shows a flowchart of a charging planning method according to an embodiment of the present disclosure.

First, the driving control apparatus of the present embodiment includes a navigation device 10 and a below-described smart charging planner 20.

As the destination is input, the navigation device 10 may determine a path from the starting point to the destination. Here, the starting point may be input by the driver. When there is no input, the current position determined through the position sensor (i.e., a global positioning system (GPS) receiver) may be determined as the starting point. It should be apparent that the navigation device 10 can determine the driving path as the departure and destination are determined in this manner.

The navigation device 10 may include a memory for storing map data. The map data may include locations of electric charging stations, types of the chargers, the locations and the speed limits of speed limit cameras, gradients of roads, curvature information of the roads, and/or the like.

The smart charging planner (or planning unit) 20 executes a charging planning model according to predetermined information. Such predetermined information may include path information to a destination, locations of electric charging stations and types of chargers, the locations of the speed limits of the cameras, gradients of roads, curvatures of the roads, and/or the like. A charging planning method is thereby performed, and a corresponding result is output.

In one embodiment, the smart charging planner 20 may include a data input/output device, at least one processor for performing determination, calculation, and determination, and a memory for storing an operating system or logic command and input/output information.

Hereinafter, the charging planning method according to one embodiment is described in detail through the flowchart of FIG. 2.

The charging planning method in one embodiment may be started from the input of the destination by a driver (S10). Depending on the input destination, the navigation device 10 determines a driving path from the starting point to the destination.

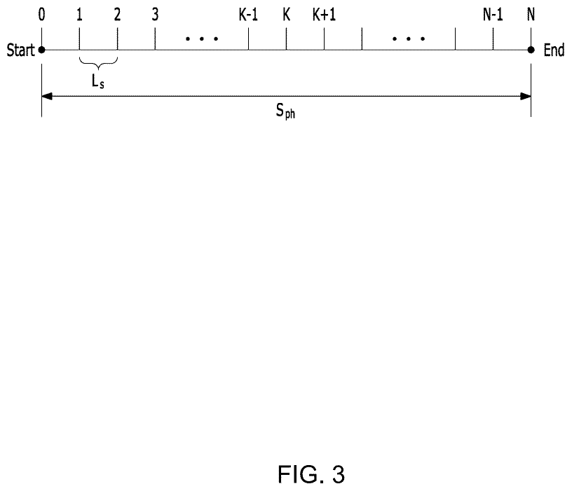

When the destination is determined, the driving path from the starting point is set as the prediction range (or prediction horizon) Sph. The prediction range Sph is divided into N number of divided unit sections as shown in FIG. 3 (S11). In one embodiment, the prediction range Sph is divided into N number of unit sections based on the basis of distance, and as an example, the distance of the traveling path of each unit section is the same.

After destination setting, the destination state of charge (SoC), which may be defined as the SoC of the vehicle at the destination, is determined. The destination SoC may be manually input by the driver (S20 and S31) or may be automatically set (S20 and S32).

In the case of manual input, the driver may input the SoC level at the destination as a percentage (%) (S31).

In the case of automatic setting, the destination SoC may be determined in consideration of the amount of SoC required for driving from the destination to the closest charging station (S32).

When the destination SoC is determined as described above (S40), information is collected from the navigation device 10 (S50). The information collected may include the locations of the charging stations, the types of the chargers (i.e., a fast charger or a slow charger), information such as the speed limit camera locations and the speed limits thereof on the driving path, and the information such as the road gradients and the curvatures on the driving path.

This may be implemented by such information being input into the smart charging planner 20 from the navigation device 10.

Next, the longitudinal motion equation, the travel time (duration), and the battery SoC for the charging planning model are modeled by state variables (S60). The objective function is also generated (S70), which is described in detail below.

The charging planning method in one embodiment includes such an objective function. A target driving force, a braking force, and a charging time (which means a period of time of charging) are output by performing a calculation to find a minimized solution of the objective function under the following constraints (S90).

As the constraints (S80), a traveling vehicle speed constraint, a motor driving force constraint depending on a vehicle speed, a motor braking force constraint, a constraint of a number of charging, an SoC constraint, a destination SoC constraint, a vehicle speed constraint according to road curvature, and the like are considered (S81 to S86).

The minimized solution of the above objective function for the prediction range is calculated under the constraints. As a result, the locations of one or more charging stations for charging the vehicle, the charging time, the driving force and/or the braking force and the vehicle speed for each unit section, and the distance to empty (DTE) are output (S120).

In this case, the braking force is distributed to the regenerative braking and/or the mechanical braking depending on the output braking force (S111 and S112).

Hereinafter, the state variable modeling (S60) of a longitudinal motion equation, the generation of the objective function (S70), the constraints (S80), and the determination of the minimized solution of the objective function (S90) are described in detail.

### State Variable Modeling (S60)

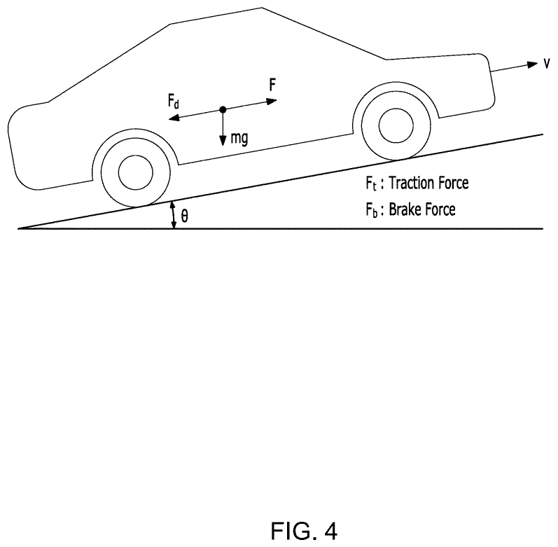

FIG. 4 shows a vehicle traveling on a road having a longitudinal gradient angle of θ. A state variable model according to a longitudinal motion equation thereof is as shown in Equation 1 below.

½m_{eq}v(k+1)²−½m_{eq}v(k)²=Lₛ (Fₜ(k)−F_{b}(k)−Fᵣ(k)) Equation 1:

In Equation 1, v(k) is a vehicle speed at the k-th node (see FIG. 3) in the prediction range, Fₜ is a wheel driving force, F_{b} is a wheel braking force, m_{eq} is a vehicle equivalent mass, Fᵣ is a resistance (i.e., one or the combination of a rolling resistance, an air resistance, a gravity resistance), and Lₛ is a travel distance of one unit section.

In Equation 1, Fᵣ may be defined as Equation 2 below to include all of the rolling, air, and gravity resistances.

Fᵣ(k)=cᵣm_{eq}g cos(θₖ)+m_{eq}g sin(θₖ)+0.5c_{d}Aρₐᵢᵣv(k)² Equation 2:

in Equation 2, Cr denotes a rolling resistance coefficient, g denotes the acceleration of gravity, Cd denotes an air resistance coefficient, A donates an effective cross-sectional area of the vehicle, and ρₐᵢᵣ denotes an air density.

From Equation 1, v(k+1) may be defined as Equation 3 below.

$$v ( k + 1 ) = \sqrt{\frac{2 ( {F}_{t} ( k ) - {F}_{b} ( k ) - {F}_{r} ( k ) ) {L}_{s}}{{m}_{eq}} + {v ( k )}^{2}} \qquad Equation 3$$

The state variable model for the travel time tₜᵣᵢₚ may be defined as Equation 4 below.

tₜᵣᵢₚ(k+1)=tₜᵣᵢₚ(k)+Lₛ/v(k) Equation 4:

In addition, the state variable model for the battery SoC may be defined as Equation 5 below.

$$soc ( k + 1 ) = soc ( k ) - \frac{{L}_{s} \cdot ( {F}_{t} ( k ) - {F}_{b} ( k ) )}{η \cdot {E}_{cap}} + \frac{{P}_{ch} ( k )}{{E}_{cap}} Δ {t}_{ch} ( k ) \qquad Equation 5$$

In Equation 5, η denotes the battery charge/discharge efficiency, E_{cap} denotes the battery capacity, P_{ch} denotes the charged power, and Δt_{ch} denotes the charging time (i.e. the duration of time for the charging).

The above Equation 5 reflects the change amount of the SoC according to the driving and regenerative braking when driving the electric vehicle, in consideration of the charging and discharging efficiencies.

For example, if it is assumed that a charging station is present at the fifth node (i.e. k is 5) in the prediction range of FIG. 3, it is determined that the charging is possible, and the charging amount is determined by Δt_{ch}. The value may be determined through a calculation to find a minimized solution of the objective function.

### Objective Function (S70)

The charging plan model in one embodiment includes an objective function based on the above-described state variable model. The objective function J may be defined as Equation 6 below.

$$J = {\sum }_{k = 0}^{N - 1} {ω}_{1} \cdot {{t}_{trip} ( k )}^{2} + {ω}_{2} \cdot {SiC ( k )}^{2} + {ω}_{3} \cdot {{t}_{trip} ( KN )}^{2} + {ω}_{4} \cdot {SoC ( N )}^{2} \qquad Equation 6$$

In Equation 6, ω1, ω2, ω3, and ω4 denote weights.

Depending on how each of the weights is determined, a target for driving to a corresponding destination may vary. In other words, if the ω1 is determined to be greater than the ω2, it results in minimizing the travel time. If the ω1 is smaller than the ω2, it results in minimizing the SoC. Whether to prioritize the travel time or the SoC may be left to the selection by the driver. That is to say, for example, it is possible to allow a driver to select any of the travel time priority and the SoC priority through the user interface in the vehicle. The ω1 and the ω2 may be changed according to the selection.

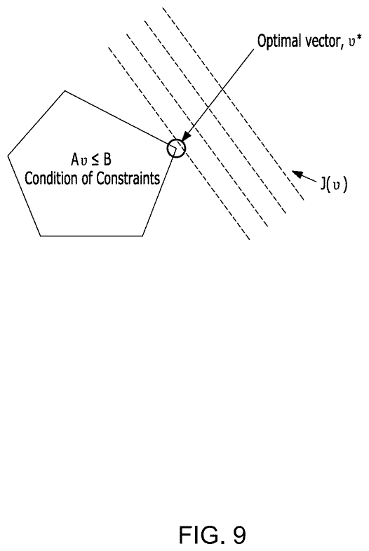

By making the objective function quadratic, a negative result value, Which is possible with a linear objective function, may be avoided. In addition, the quadratic objective function may help overcome the disadvantage that the solution may be determined as corners of the constraints with the linear objective function as shown in FIG. 9.

The objective function may be expressed by the following input variable vector U and the state variable vector X according to Equations 7. The minimized solution may be obtained by forming the objective function as a vector equation with respect to all of the unit sections and then performing a calculation to fine the minimized solution.

X=[v, tₜᵣᵢₚ, SoC]

U=[Fₜ, F_{b}, Δt_{ch}] Equations 7:

### Constraints (S80)

### (1) Vehicle Speed Constraint (S81)

There may be a speed limit for the vehicle speed on the driving path, and the vehicle speed constraint condition is for this purpose. The present constraint condition may be defined as Equation 8 below.

max(Vₘᵢₙ(k)·(1−Δt_{ch}(k), 0))≤v(k)≤max(Vₘₐₓ(k)·(1−Δt_{ch}(k), 0)) Equation 8:

In Equation 8, since Δt_{ch} is greater than 0 (zero) at the time of charging, it is the same as the following Equation.

0≤v(k)≤0 Equation 9:

Also, because Δt_{ch} becomes 0 (zero) when the battery is not charged, it is the same as the following equation.

Vₘᵢₙ(k)≤v(k)≤Vₘₐₓ(k) Equation 10:

The vehicle speed limit Vmax may vary depending on the type of a road (i.e., an urban road, a local road, an expressway, a national highway, or the like). The vehicle speed limit may be included in the navigation map information, and the information herein may be used.

In Equation 10, the lower limit Vmin of the vehicle speed may be a lower limit of the vehicle speed defined on the road or a value automatically determined by the system according to a selection by the driver or the determination of the drive mode.

### (2) Constraint on Motor Driving Force According to a Vehicle Speed

This constraint is a condition due to a torque limitation of the drive motor.

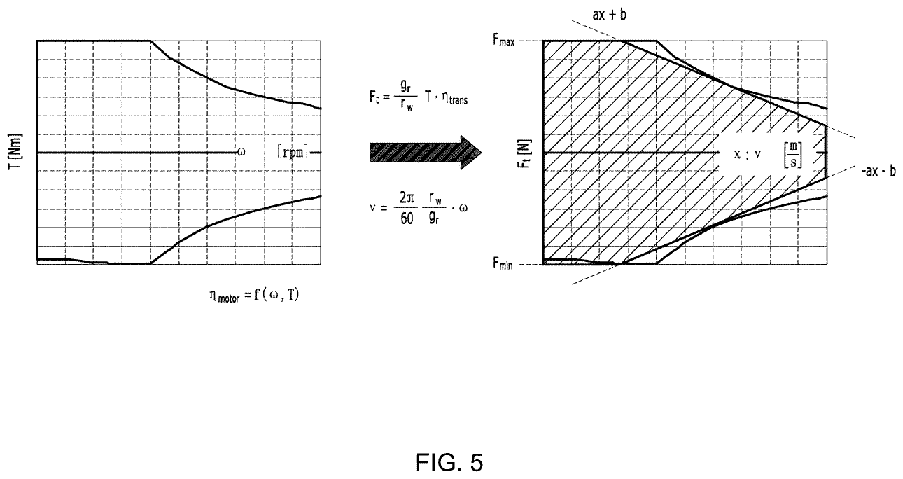

The left drawing of FIG. 5 shows a relationship of the torque and the efficiency for a motor, which is changed into the right drawing by transforming into the relationship between the square of the vehicle speed and the driving force and approximating the curved portion into a straight line.

In FIG. 5, Fₘₐₓ and Fₘᵢₙ are the same as Equation 11 below.

$${F}_{max} = \frac{{g}_{x}}{{r}_{w}} {T}_{max} \cdot {η}_{trans} , {F}_{min} = \frac{{g}_{x}}{{r}_{w}} {T}_{min} \cdot {η}_{trans} \qquad Equation 11$$

As an example, the constraints limit the driving force within the area shaded in the right drawing of FIG. 5. Maximum and minimum conditions thereof are expressed as Equation 12 below.

F_{t,min}≤input, u≤F_{t,max} Equation 12:

In Equation 12, F_{t, max} and F_{t, min} are the same as Equation 13 below.

F_{t,min}=max(Fₘᵢₙ, −ax−b) F_{t,max}=min(Fₘₐₓ, ax+b) Equation 13:

### (3) Motor Braking Force Constraint (S83)

There may be limits (Fb, max) of the regenerative braking force by the motor, and the present constraint relate thereto. For example, the present constraint may be defined in Equation 14 below.

0≤F_{b,k}≤F_{b,max} Equation 14:

### (4) Constraint on the Number of Times of Charging (S84)

The number of times of charging represents the number of stopping at charging stations on the driving path to charge the vehicle. This condition is a constraint on the number of times of charging.

The number of times of charging may be selected by the driver or may be automatically increased or decreased with a default value.

As a default value, 1 may be set as the constraint of the number of charging.

### (5) SoC Operating Condition Constraint (S85)

The present constraint as an SoC operating condition of the battery may determine a minimum value SoCmin and a maximum value SoCmax thereof and may be defined as Equation 15 below.

SoCₘᵢₙ≤SoCₖ≤SoCₘₐₓ Equation 15:

### (6) Destination SoC Constraint (S86)

This condition is a constraint by the determined value (SoC_{min, N}) in step S40 described above, and may be defined as Equation 16 below.

SoC_{min,N}≤SoC_{N} Equation 16:

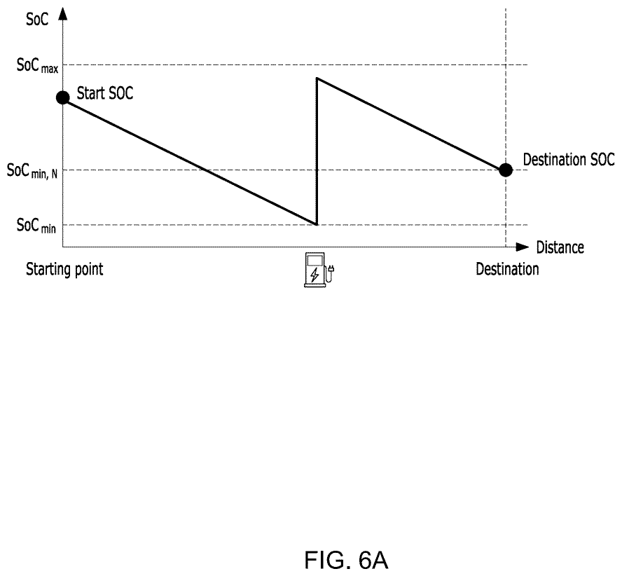

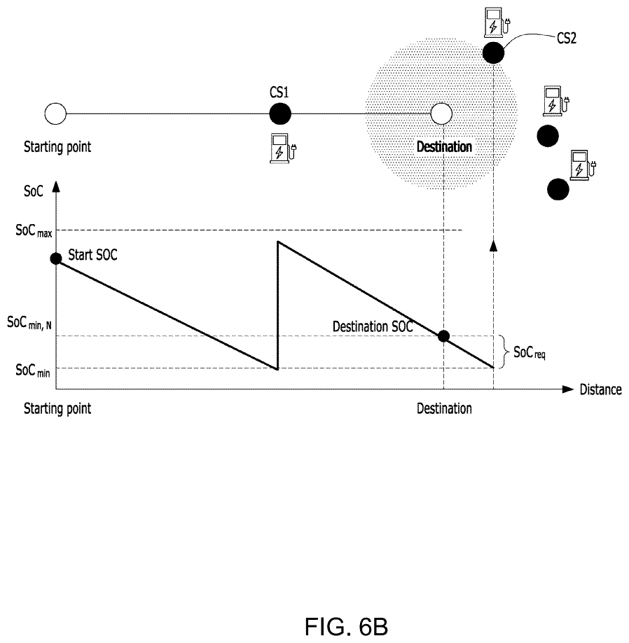

FIG. 6A illustrates a case where the driver manually inputs the destination SoC condition (SoC_{min, N}) where the charging is performed once during the traveling path to the destination, and where the SoC condition (SoC_{min, N}) is satisfied at the final destination.

FIG. 6B illustrates an example in which the SoC condition (SoC_{min, N}) of the destination is arbitrarily determined. FIG. 6B shows that the SoC (SoC_{req}), which is required to reach the location of the nearest charging station CS2 after arriving at the destination, is determined as the SoC condition (SoC_{min, N}) of the destination.

In FIG. 6B, a charging is performed at the charging station CS1 on the driving path to the destination, and the SoC condition (SoC_{min, N}) satisfied at the destination.

### (7) Vehicle Speed Constraint Depending on Road Curvature (S87)

This constraint is a condition where the maximum vehicle speed is restricted for safety when the vehicle turns on a curved section of a road.

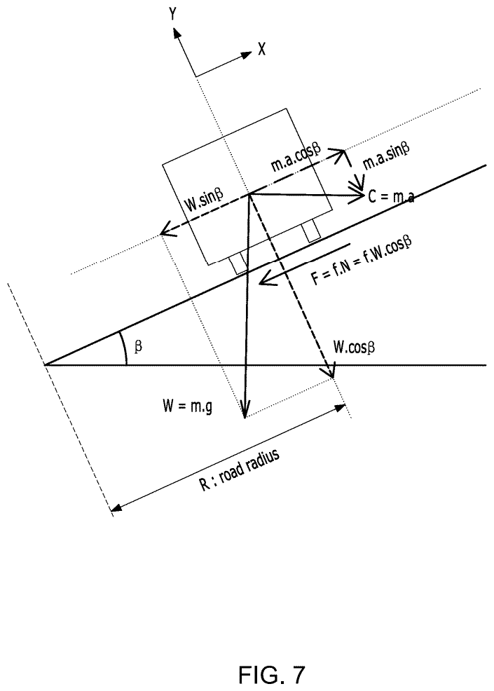

In the driving state of the vehicle as shown in FIG. 7, a maximum vehicle speed for safety may be obtained with a condition that the sum of all forces acting on the vehicle is zero with respect to the lateral gradient (gradient of the bank part of the road) β of the road, the curvature of the road [symbol] , and the coefficient f of friction of the road surface. The constraint to limit the vehicle speed to the maximum vehicle speed may be expressed as Equation 17 below.

$${v}^{2} \leq \frac{g \cdot ( tan β + f )}{k} \qquad Equation 17$$

In Equation 17, g is acceleration of gravity.

Although the above constraints have been described, the constraints are not limited thereto. It should be apparent that additional constraints may be applied in consideration of safety, efficiency, selection by the driver, and/or the like.

All constraints can also be expressed by input variables using the state variable model equation and expressed in a vector form.

### (8) Optimal (Minimized) Solution Calculation (S90)

This step is a process of calculating the optimal solution (minimized solution) by applying the above constraints to the objective function described above.

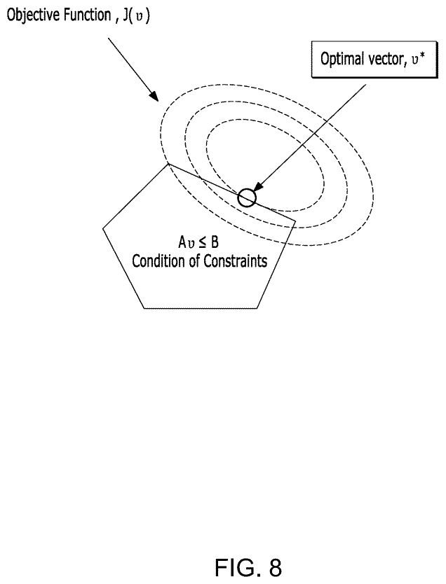

FIG. 8 schematically illustrates an optimal solution calculation process. As shown in FIG. 8, optimal driving forces (uₒₚₜ and Fₜ,), optimal braking forces (uₒₚₜ and F_{b},), and optimal charging times (i.e. optimal periods of time of charging) (uₒₚₜ and _{Δtch)} are calculated by quadratic programming with the above-described constraints applied.

The optimal solution may be obtained as an optimal solution vector u* for all unit sections within the prediction range.

In this case, the regenerative braking distribution may be determined depending on the magnitude of the braking force F_{b}* obtained by the optimal solution (S100).

Initially, when the braking force F_{b}* obtained by the optimal solution exceeds the regenerative limit Fmin of the motor, the braking force Fb* is distributed to the mechanical braking forces (u_{add, Fb, mech}) as much as the optimal solution braking force Fb* reduced to the regenerative limit Fmin of the motor.

When the braking force Fb* obtained by the optimum solution is equal to or less than the regenerative limit Fmin of the motor, the optimal driving force (u_{opt, Ft}) is determined by the difference between the driving force Ft* obtained by the solution and the braking force Fb*, and the regenerative braking and the mechanical braking become 0 (zero).

From the following step S120, the charging location and the charging time of a charging station to be charged during the travel to the destination, a vehicle speed for each unit section, a DTE, and the like are determined.

The smart charging planner 20 determines the position of the charging station to be Charged with the vehicle speed and the DTE, the driving force and the braking force, and the like. The smart charging planner 20 also determines the charging time thereof for each unit section the prediction range according to the above-described charging planning method before departure. However, the plan thereof may be different when actually traveling. In addition, the driving path to the destination may be changed due to a traffic situation, a deviation of the driver from the initial driving path, and/or the like.

In this case, the smart charging planner 20 may reset the prediction range for a driving path from the current location to the destination and may again execute the charging planning method described above.

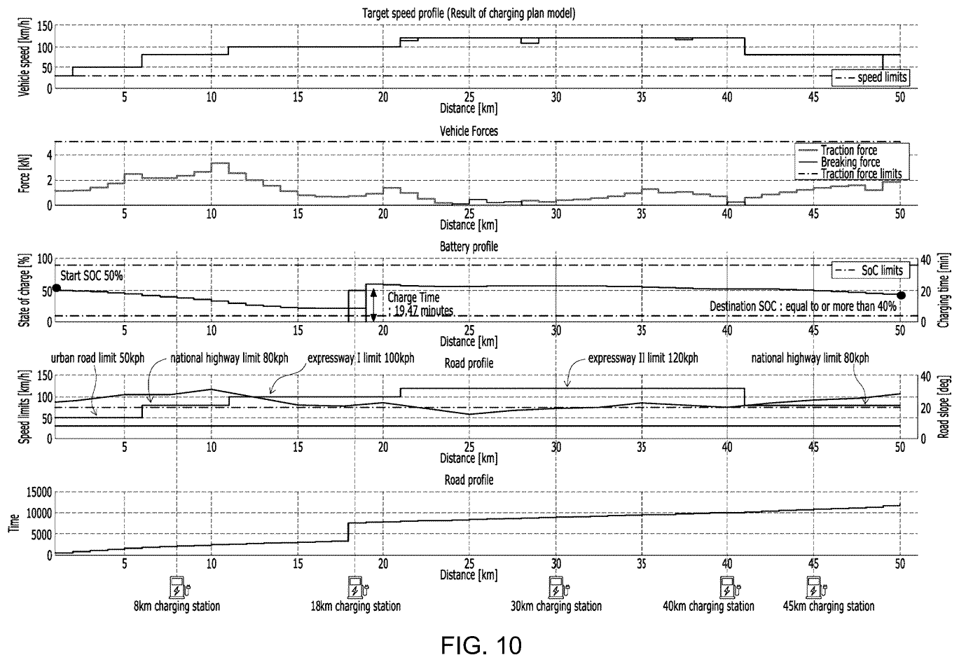

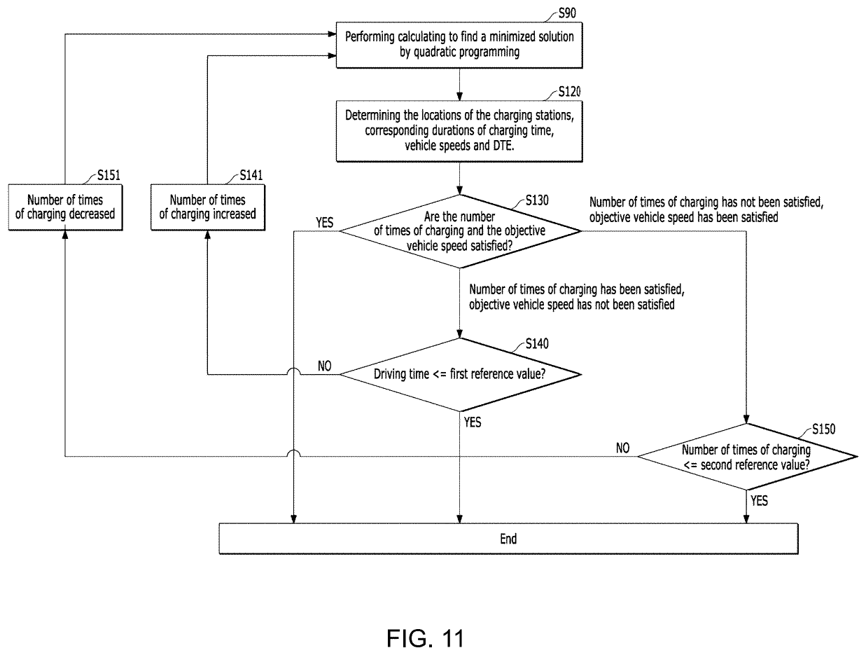

FIGS. 10 and 11 illustrate a simulation result executed by the smart charging planner 20 according to the charging planning method of the present embodiment described below.

In this example, the prediction range is 50 km and the distance of each unit section is 1 km.

The vehicle speed limit within the prediction range of the present example as shown in FIG. 10 is 50 km/h for an urban road, 80 km/h for a national highway, 100 km/h for an expressway I, 12 km/h for an expressway II, and 30 km/h for a minimum speed (Vmin) limit.

The road gradient according to the distance from the starting point for the prediction range of this embodiment is shown in FIG. 10.

Also, within the prediction range, the charging station is located at points of 8 km, 18 km, 30 km, 40 km and 45 km as shown in FIG. 10.

The case was assumed that the battery SoC is initially 50% and the destination SoC constraint is determined to be 40% by the selection of the driver. In addition, the number of times of charging was assumed to be one.

As a result of calculating the minimized solution of the objective function according to the above-described charging planning method with respect to the above example, it concludes that the shortest ravel time is achieved when a single charging is performed at the point of 18 km. Herein, the charging time is 19.47 minutes, and the SoC slightly exceeds 50% from charging.

Here, if the charging is performed at the point of 8 km, the total travel time is increased by roughly 6.4%. If the charging is performed at the point of 30 km, the total travel time is increased by roughly 5.9%.

Meanwhile, the charging plan result for a single charging may not be satisfied. An embodiment thereof is described with reference to FIG. 11.

Steps S90 and S120 of FIG. 11 are the same as those of FIG. 2. In other words, as shown in FIG. 11, in this embodiment, operations S130, S140, S141, S150, and S151 are added to the embodiment of FIG. 2.

As shown in FIG. 11 after step S120, it is determined whether the number of times of charging and the speed of the target vehicle are satisfied (S130). The process is terminated when all conditions are satisfied as shown in FIG. 2.

Here, whether the number of times of charging is satisfied may be determined by a set predetermined value for the number of times of charging. The predetermined value may be determined by default or by a selection of the driver. Alternatively, the result may be output on the display in the vehicle at step S120, and whether the number of times of charging is satisfied may be determined by the selection by the driver.

Whether the target vehicle speed is satisfied may also be determined by a set predetermined value for the target vehicle speed. The predetermined value may be determined by default or selection by the driver. Alternatively, the result may be output to the display screen in the vehicle in step S120, and whether the target vehicle speed is satisfied may be determined by selection by the driver.

Regarding whether the number of times of charging and the target vehicle speed are satisfied, when both are not satisfied but one, steps S140, S141, S150, and S151 are performed.

First, when the number of times of charging is satisfied but the target vehicle speed is not satisfied (i.e., when the target vehicle speed is low or small) and the travel time is equal to or less than a first predetermined value (Yes in S140), the process is terminated. Otherwise, when the travel time exceeds the first predetermined value, the process returns to Step S90 (No in S140). In this case, the constraint value (i.e. the number of times of charging) of the constraint of the number of times of charging (S141) is increased, and step S90 is performed. The increase in the number of times of charging means an increase in available battery energy. Accordingly, an increased target vehicle speed may be obtained.

Meanwhile, when the number of times of charging is not satisfied but the target vehicle speed is satisfied and the number of times of charging is equal to or less than a second predetermined value (Yes in S150), the process is terminated. Otherwise, i.e., if the travel time exceeds the second predetermined value (No in S150), the process returns to step S90. In this case, the number of times of charging is decreased in the constraint of the number of times of charging (S151), and step S90 is performed. Although the target vehicle speed may be reduced due to the reduction of the number of times of charging, the S130 may achieve the vehicle speed satisfaction.

Here, the first predetermined value and the second predetermined value may be determined by the selection by the driver.

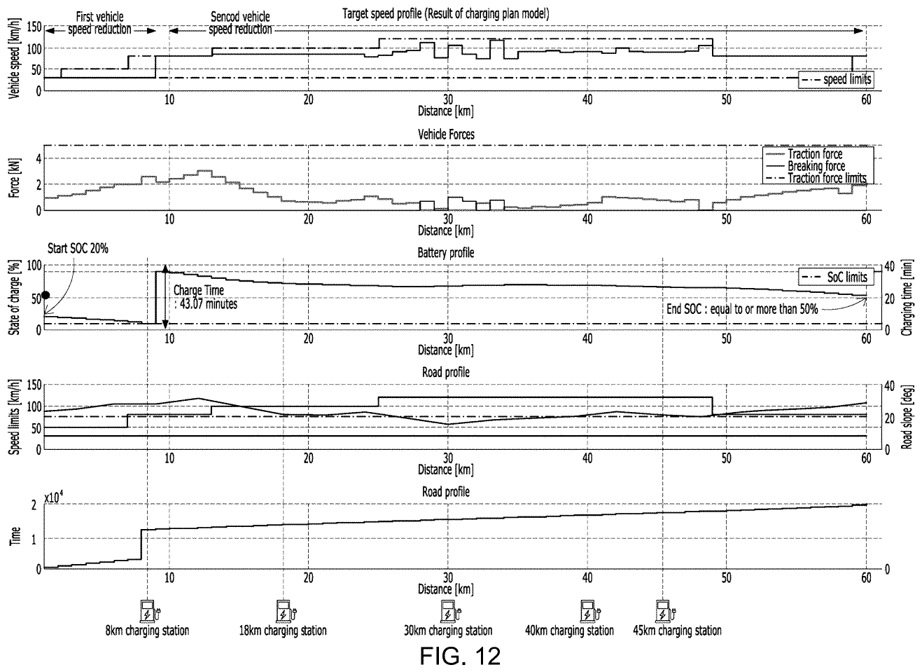

FIG. 12 shows a simulation result for a case where the current SoC is 20% and the destination SoC is 50% or more in the same situation as that of FIG. 10.

Since the initial SoC in this example is 20%, charging is required at the charging station of a point of 8 km, and it is necessary to primarily slow down the vehicle speed (first vehicle speed reduction) in order to drive to that point. As shown in the example of FIG. 12, it may be understood that the vehicle is driven at the lower limit of the vehicle speed of 30 km until the charging station at the point of 8 km is reached.

Since the destination SoC is also 50% or more in this case, the vehicle speed is lowered after charging compared to FIG. 10.

In the second vehicle speed reduction section of FIG. 12, even though the SoC is charged up to the set maximum value of 90% at the charging station of the point of 8 km, because the destination SoC of 50% or more is required to be satisfied, the target vehicle speed is determined to minimize the consumption of the SoC to meet the destination SoC of 50% or more. This is so even with a default (or initial) target vehicle speed being set to the limit for each road.

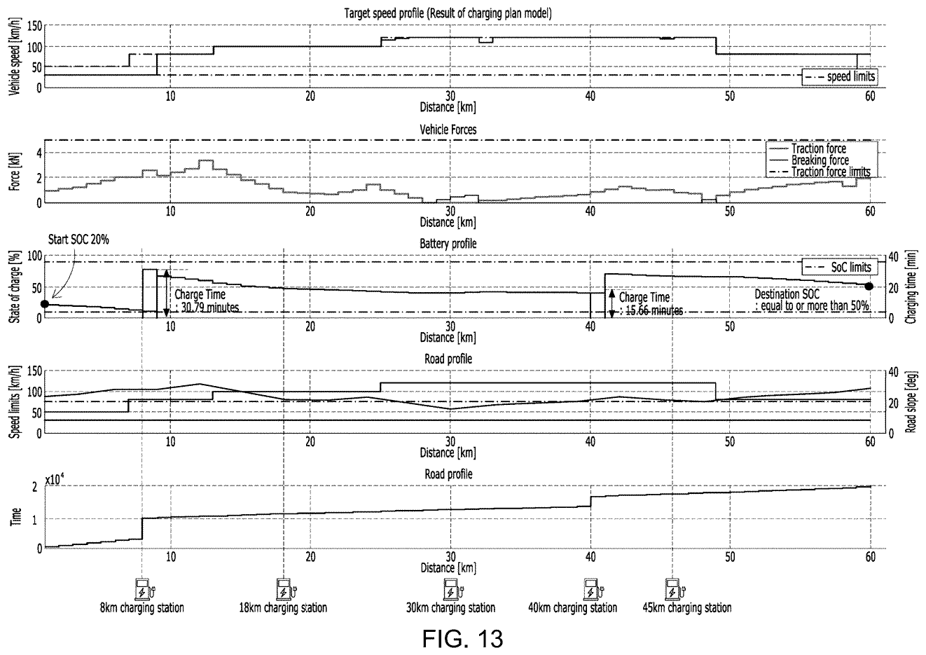

FIG. 13 shows a simulation result for a case where the current SoC is 20% and the destination SoC is 50% or more in the same case as that of FIG. 10.

FIG. 13 assumes that the step S90 is performed again by increasing the number of times of charging because the result of FIG. 12 is not satisfied with the target vehicle speed.

Since the initial SoC is also 20% from the present example, charging is required at a charging station of the point of 8 km. It is necessary to primarily slow down the vehicle speed in order to drive until that point. Unlike the case of FIG. 12, the charging time and the charging amount are relatively small when the first charging is performed at the charging station of 8 km.

Instead, charging is performed once more at a charging station of a point of 40 km.

In the case of FIG. 13, the number of times of charging is increased compared to the case of FIG. 12 so that the total available energy for the battery is increased, thereby increasing the target vehicle speed.

Referring to the target vehicle speed shown in the above graph of FIG. 13, it is shown that the target vehicle speed is increased compared to the case of FIG. 12.

The method for planning battery charging and vehicle driving control of the above-described embodiment may be applied to any vehicle that can be driven by a motor such as a hybrid vehicle or an electric vehicle.

The foregoing descriptions of specific embodiments of the present disclosure have been presented for purposes of illustration and description. The descriptions are not intended to be exhaustive or to limit the present disclosure to the precise forms disclosed. Many modifications and variations are possible in light of the above teachings. The disclosed embodiments were chosen and described to explain certain principles of the present disclosure and their practical application and to enable others of ordinary skill in the art to make and utilize various embodiments of the present disclosure, as well as various alternatives and modifications thereof. It is intended that the scope of the present disclosure be defined by the appended claims and their equivalents.

### DESCRIPTION OF SYMBOLS

10: Navigation device
20: Smart charging planner

What is claimed is:

1. A method of planning to charge an electric vehicle, the method comprising:
determining a driving path based on a destination;
dividing a prediction range on the driving path into a plurality of sections;
obtaining driving environment information of the driving path; and
applying the driving environment information to a charging plan model for each of the plurality of sections using and establishing a charging plan on the driving path by collectively calculating to find a minimized solution of the charging plan model for the plurality of sections,
wherein the charging plan model includes an objective function of travel time and battery state of charge (SOC), the objective function based on a first model according t a longitudinal motion equation of the vehicle, a second model for the travel time, and a third model for the battery SOC.

2. The method of claim 1, wherein the first model is defined as a relationship between a vehicle speed and a driving force and a braking force, wherein the second model is defined as a relationship between a vehicle speed and a travel distance, and wherein the third model is defined based on power consumed by the vehicle while travelling, power charged by regenerative braking, and power charged by a charger.

3. The method of claim 1, wherein the objective function includes a sum of weighted terms of the travel time and the battery SoC.

4. The method of claim 3, wherein the term of the travel time includes a square of the travel time, and the term of the battery SoC includes a square of the battery SoC.

5. The method of claim 1, wherein the driving environment information includes at least one of charging station information, a road gradient, a road curvature, a speed limit, or a speed limit camera location, or any combination thereof.

6. The method of claim 1, wherein the charging planning model includes at least one of a vehicle speed constraint, a motor driving force constraint depending on a vehicle speed, a motor braking force constraint, a constraint of a number of times of charging, an SoC operation constraint, a destination SoC constraint, or a vehicle speed constraint depending on road curvature, or any combination thereof.

7. The method of claim 6, wherein collectively calculating to find the minimized solution includes performing a first calculation to find the minimized solution and then determining whether the number of times of charging and a target vehicle speed are satisfied and includes performing a second calculation to find the minimized solution according to a result of the determining.

8. The method of claim 7, wherein, when the number of times of charging is satisfied but the target vehicle speed is not satisfied, performing the second calculation includes terminating collectively calculating without the second calculation if a travel time resulted from the first calculation is satisfied and otherwise performing the second calculation with a number of times of charging of the constraint of the number of times of charging increased.

9. The method of claim 7, wherein, when the target vehicle speed is satisfied but the number of times of charging is not satisfied, performing the second calculation includes terminating collectively calculating without the second calculation if the number of times of charging resulted from the first calculation is equal to or smaller than a predetermined value and otherwise performing the second calculation with a number of times of charging of the constraint of the number of times of charging decreased.

10. The method of claim 6, wherein the destination SoC is determined by a selection of a driver.

11. The method of claim 6, wherein the destination SoC is determined depending on a location of a charging station closest from the destination.

12. A non-transitory computer-readable storage medium storing a computer program code for performing a method of planning to charge an electric vehicle by being executed by a processor, wherein the processor is configured to:
determine a driving path based on a destination;
divide a prediction range on the driving path into a plurality of sections;
obtain driving environment information of the driving path; and
apply the driving environment information to a charging plan model for each of the plurality of sections using and establish a charging plan on the driving path by collectively calculating to find a minimized solution of the charging plan model for the plurality of sections,
wherein the charging plan model includes an objective function of travel time and battery state of charge (SOC), the objective function being defined based on a first model according to a longitudinal motion equation of the vehicle, a second model for the travel time, and a third model for the battery SOC.

13. A driving control apparatus comprising:
a navigation device configured to determine a driving path based on a destination; and
a charging planner including at least one computer processor configured to perform a charging planning operation, wherein the charging planning operation includes
dividing a prediction range on the driving path into a plurality of sections,
obtaining driving environment information of the driving path, and
applying the driving environment information to a charging plan model for each of the plurality of sections using and establishing a charging plan on the driving path by collectively calculating to find a minimized solution of the charging plan model for the plurality of sections,
wherein the charging plan model includes an objective function of travel time and battery state of charge (SOC), the objective function being defined based on a first model according to a longitudinal motion equation of the vehicle, a second model for the travel time, and a third model for the battery SOC.

14. The driving control apparatus of claim 13, wherein the first model is defined as a relationship between a vehicle speed and a driving force and a braking force, wherein the second model is defined as a relationship between a vehicle speed and a travel distance, and wherein the third model is defined based on power consumed by the vehicle while travelling, power charged by regenerative braking, and power charged by a charger.

15. The driving control apparatus of claim 13, wherein the objective function includes a sum of weighted terms of the travel time and the battery SoC, and wherein the term of the travel time includes a square of the travel time and the term of the battery SoC includes a square of the battery SoC.

16. The driving control apparatus of claim 13, wherein the driving environment information includes at least one of charging station information, a road gradient, a road curvature, a speed limit, or a speed limit camera location, or any combination thereof.

17. The driving control apparatus of claim 13, wherein the charging planning model includes at least one of a vehicle speed constraint, a motor driving force constraint depending on a vehicle speed, a motor braking force constraint, a constraint of a number of times of charging, an SoC operation constraint, a destination SoC constraint, or a vehicle speed constraint depending on road curvature, or any combination thereof.

18. The driving control apparatus of claim 17, wherein collectively calculating to find the minimized solution includes performing a first calculation to find the Minimized solution and then determining whether the number of times of charging and a target vehicle speed are satisfied, and includes performing a second calculation to find the minimized solution according to a result of the determining.

19. The driving control apparatus of claim 18, wherein, when the number of times of charging is satisfied but the target vehicle speed is not satisfied, performing the second calculation includes terminating the collectively calculating without the second calculation if a travel time resulted from the first calculation is satisfied and otherwise performing the second calculation with a number of times of charging of the constraint of the number of times of charging increased, and
Wherein, when the target vehicle speed is satisfied but the number of times of charging is not satisfied, performing the second calculation includes terminating the collectively calculating without the second calculation if the number of times of charging resulted from the first calculation is equal to or smaller than a predetermined value and otherwise performing the second calculation with a number of times of charging of the constraint of the number of times of charging decreased.

20. The driving control apparatus of claim 17, wherein the destination SoC is determined by a selection of a driver or is determined depending on a location of a charging station closest from the destination.
